(19) United States
(12) Patent Application Publication
(10) Pub. No.: US 2026/0308466 A1
(43) Pub. Date: Oct. 8, 2026

(54) GASIFICATION

(71) Applicants: Gary John Pikington WILLIAMS, Olifantsfontein (ZA); TCG GLOBAL, LLC, Parker, CO (US)

(72) Inventors: Gary John Pilkington WILLIAMS, Olifantsfontein (ZA); Marcus Kent WILEY, Parker, CO (US); Darlene Kaye SHERROD, Bentonville, AR (US)

(73) Assignee: TCG GLOBAL, LLC, Parker, CO (US)

(21) Appl. No.: 19/482,850

(22) PCT Filed: May 17, 2024
(86) PCT No.: PCT/IB2024/054805

§ 371 Date: Nov. 10, 2025

Related U.S. Application Data
(60) Provisional application No. 63/503,375, filed on May 19, 2023.

(51) Int. Cl. C10J 3/66

(52) U.S. Cl. CPC C10J 3/66; C10J 2300/0916; C10J 2300/0976; C10J 2300/1246; C10J 2300/1884

(57) ABSTRACT

The disclosed invention relates to a method of and process for gasifying a carbonaceous feedstock. The method includes the following steps: pyrolysing a carbonaceous feedstock, by effecting heat exchange between heated gas and the carbonaceous feedstock under non-oxidizing conditions through direct and/or indirect contact between the heated gas and carbonaceous feedstock, and thus producing a pyrolysis gas and a solid pyrolysed product; gasifying the solid pyrolysed product, thus producing syngas; producing heat of combustion by combusting at least some of the syngas and/or hydrogen recovered from the syngas; effecting heat exchange between the heat of combustion and the pyrolysis gas, to produce heated pyrolysis gas; and using the heated pyrolysis gas to provide at least some of the heat to perform the pyrolysis of the carbonaceous feedstock.

### FIELD OF THE INVENTION

THIS INVENTION relates to gasification, particularly as applied in producing syngas from a carbonaceous feedstock. The invention provides a process for gasifying a carbonaceous feedstock.

### SUMMARY OF THE INVENTION

IN ACCORDANCE WITH ONE ASPECT OF THE INVENTION IS PROVIDED a process for gasifying a carbonaceous feedstock, the process comprising
in a pyrolysis stage comprising a pyrolysis reactor, effecting heat exchange under non-oxidizing conditions inside the pyrolysis reactor between a carbonaceous feedstock and heated gas to produce pyrolysis gas and a solid pyrolysed product;
in a gasification stage, subjecting the solid pyrolysed product to gasification, to produce syngas;
in a heat generation stage, generating heat by combusting at least some of the syngas and/or hydrogen recovered from at least some of the syngas;
in a heating stage, effecting heat exchange between the heat generated in the heat generation stage and pyrolysis gas produced in and recovered from the pyrolysis stage, to produce heated pyrolysis gas; and
recycling the heated pyrolysis gas to the pyrolysis stage and feeding it into the interior of the pyrolysis reactor to provide at least some of the heat to perform the pyrolysis.

Combustion gas may be produced in the heat generation stage as a result of the combustion of syngas and/or hydrogen in the heat generation stage. Such combustion gas may be recovered from the heat generation stage or from the heating stage, and may be fed into the interior of the pyrolysis reactor also to provide at least some of the heat to perform pyrolysis.

The heated pyrolysis gas may be fed into the interior of the pyrolysis reactor along with steam and/or ionized steam.

The heated pyrolysis gas may be at a temperature of about 350 to about 750 degrees Celsius.

Feeding heated pyrolysis gas, recycled to the pyrolysis stage, into the interior of the pyrolysis reactor, may be in a direction that is opposite to the direction in which the carbonaceous feedstock is fed into and moves along inside the pyrolysis reactor (i.e., countercurrent).

Feeding of heated pyrolysis gas, recycled to the pyrolysis stage, into the interior of the pyrolysis reactor may be performed such that the heated pyrolysis gas so recycled is brought into direct contact with the carbonaceous feedstock.

The pyrolysis reactor may comprise a first compartment/chamber and a second compartment/chamber separated from the first compartment by a heat exchange wall. The second compartment/chamber may provide a jacket for the first compartment/chamber, with the first compartment/chamber thus being located within, i.e., being surrounded by, the second compartment/chamber.

In such a configuration of the pyrolysis reactor, the carbonaceous feedstock may be fed into the first compartment. The heated pyrolysis gas, optionally along with steam and/or ionized steam, may also be fed into the first compartment in a direction that is opposite to the direction of feed and movement of the carbonaceous feedstock inside the pyrolysis reactor (i.e., countercurrent). Thus, direct contact heat exchange between the heated pyrolysis gas (optionally along with steam and/or ionized steam) and carbonaceous feedstock may occur, thus effecting pyrolysis of the carbonaceous feedstock.

At least some of the combustion gas, obtained from the heat generation stage and/or from the heating stage as hereinbefore described, may be fed into the second compartment. Such feeding may also be performed such that the combustion gas flows in a direction opposite to the direction in which the feedstock is being introduced into or moves in the first compartment.

By feeding at least some of the combustion gas into the jacket formed by the second compartment around the first compartment, the first compartment is provided with ambient heat. Heat exchange between the combustion gas in the second compartment and the carbonaceous feedstock may be effected through the heat exchange wall in which heat from the combustion gas in the second compartment may be transferred to the carbonaceous feedstock via the heat exchange wall to also provide additional heat to effect pyrolysis.

The heat generated in the heat generation stage may be carried by the combustion gas formed during the combustion of the syngas and/or hydrogen recovered from the syngas.

Some of the heat generated from the heat generation stage, which is carried by the combustion gas, may be directed to the gasification stage to provide some of the heat to perform gasification.

In the gasification stage, the production of syngas from the solid pyrolysed product may include converting the solid pyrolysed product into a gaseous form of carbon followed by reacting the carbon in gaseous form with steam, using steam reformation. The temperature of the syngas obtained from the gasification stage may range between about 900 and about 995 degrees Celsius.

The process may comprise a gas compression stage to compress the heated pyrolysis gas prior to feeding same into the pyrolysis stage.

In accordance with the invention, it will be appreciated that at first, the energy required to operate the pyrolysis stage and the gasification stage may be obtained from external energy/power sources such as electricity and/or fuel, however the generation of the syngas and combustion thereof gradually abates the use of the external energy/power sources until essentially the pyrolysis and gasification stages do not require the use of external energy sources to provide the heat required to perform pyrolysis and gasification in the pyrolysis and gasification stages, respectively.

The process may comprise a feedstock preparation stage to produce carbonaceous feedstock.

The carbonaceous feedstock may be a blend of raw feed material including biomass and/or fossil fuel-based carbonaceous material with water and/or steam.

The process may comprise a syngas treatment stage, to treat, typically by quenching, the syngas obtained from the gasification stage.

In the syngas treatment stage, the quenched syngas may be subjected to purification in which impurities including particulate matter such as, ash that is entrained in the syngas, is removed from the syngas.

The temperature of the treated syngas obtained from the syngas treatment stage may range between about 12 and about 95 degrees Celsius.

The process may optionally comprise a hydrogen separation stage, in which hydrogen is separated and recovered from at least some of the syngas.

A remaining portion of the syngas which may have been stripped of the hydrogen may be stored in a container for use downstream in another process, for example, a power generating process.

Optionally, a portion of the syngas obtained from the gasification stage and/or obtained from the syngas treatment stage, may be fed into the hydrogen separation stage to produce the hydrogen gas.

Optionally, a portion of the syngas that is obtained from the gasification stage and/or the hydrogen separation stage and/or treatment stage, may be fed back into the pyrolysis stage and/or gasification stage to affect/modify the syngas composition ratios.

The syngas that is combusted in the heat generation stage may be a portion of the syngas obtained from the gasification stage and/or obtained from the syngas treatment stage.

Both the syngas and the hydrogen may be combusted in the heat generation stage to produce the heat of combustion.

The combustion of the syngas and/or hydrogen gas may be exothermic, which in turn will result in the formed combustion gas being released from the heat generation stage at an elevated temperature. The temperature of the heat of combustion gas may be about 650 degrees Celsius. It will be appreciated that the temperature of the heat of combustion may vary depending on the amount of heat required for heating (i.e., effecting pyrolysis to) the carbonaceous feedstock.

A remaining portion of the syngas that is neither combusted in the heat generation stage nor from which hydrogen gas has been stripped, may be contained in a vessel and/or fed into a power generation stage, such as, an Allam-Fetvedt Cycle process, to produce electricity.

IN ACCORDANCE WITH ANOTHER ASPECT OF THE INVENTION THERE IS PROVIDED a method of gasifying a carbonaceous feedstock, the method including
pyrolysing a carbonaceous feedstock, by effecting heat exchange between heated gas and the carbonaceous feedstock under non-oxidizing conditions through direct and/or indirect contact between the heated gas and carbonaceous feedstock, and thus producing a pyrolysis gas and a solid pyrolysed product;
gasifying the solid pyrolysed product, thus producing syngas;
producing heat of combustion by combusting at least some of the syngas and/or hydrogen recovered from the syngas;
effecting heat exchange between the heat of combustion and the pyrolysis gas, to produce heated pyrolysis gas; and
using/feeding the heated pyrolysis gas to provide at least some of the heat to perform the pyrolysis of the carbonaceous feedstock, until such time as the heat obtained from the heated gas is at least partly or ultimately replaced by the heat obtained from the heated pyrolysis gas.

The heated gas may be heated inert gas. Typically, in order to obtain the heated inert gas, a fuel source may be combusted and the heat of combustion obtained therefrom may be used to heat the inert gas, thus producing heated inert gas.

In the context of the present invention, the term inert gas means that the gas does not react with the carbonaceous feedstock but is merely used to provide the heat required to effect pyrolysis.

The pyrolysing step may be effected inside of a pyrolysis reactor having a first compartment separated from a second compartment by a heat exchange wall, wherein the second compartment forms a jacket for the first compartment.

The pyrolysing step may include effecting heat exchange, inside the pyrolysis reactor, between the carbonaceous feedstock and heated inert gas, heated pyrolysis gas, and/or combustion gas (obtained from the combustion of the syngas and/or hydrogen).

The method may include effecting heat exchange directly between the heated pyrolysis gas and the carbonaceous feedstock by directly contacting the heated pyrolysis gas, which is recycled back into the pyrolysis reactor, with the carbonaceous feedstock inside of the pyrolysis reactor. The heated pyrolysis gas and the carbonaceous feedstock may be moving in opposite directions inside of the first compartment of the pyrolysis reactor while the heat exchange is being effected.

The method may also include effecting heat exchange between the heat of combustion obtained from at least some of the combustion gas and the carbonaceous feedstock through the heat exchange wall. The heat of combustion carried by the combustion gas may be introduced inside the second compartment of the pyrolysis reactor and may be arranged to indirectly provide heat into the first compartment via the heat exchange wall and thus provide ambient heating to the first compartment. The ambient heating may contribute to the heat required to further effect pyrolysis of the carbonaceous feedstock.

The heated pyrolysis gas used in the pyrolysis step may flow in a direction/flow path that is opposite to the direction in which the carbonaceous feedstock is moving/flowing inside the pyrolysis reactor.

The carbonaceous feedstock may include a blend of water, steam, ionized water, and/or ionized steam with biomass and/or a fossil fuel-based carbonaceous material. Some of the heat of combustion (obtained from combusting the syngas and/or hydrogen) may be used for gasifying the solid pyrolysed product.

The method may comprise the step of compressing the heated pyrolysis gas prior to using the heated pyrolysis gas in pyrolysing the carbonaceous feedstock.

The method may also include the step of treating the syngas produced from the gasification of the solid pyrolysed product, wherein the step of treating the syngas includes quenching the syngas in water, preferably ionized water, to reduce the temperature of the syngas. Furthermore, the step of treating the syngas, may include removing impurities including particulate matter such as, ash that is entrained in the syngas, from the syngas, thus obtaining treated syngas.

The method may optionally include the step of separating (i.e., stripping) hydrogen from the syngas and recovering the hydrogen.

The step of stripping the syngas may occur either after the gasifying step or the treating step, preferably after the gasifying step.

The syngas that is combusted in the step of generating heat of combustion may be a portion of the syngas obtained from the gasifying step and/or obtained from the syngas treatment step.

IN ACCORDANCE WITH YET ANOTHER ASPECT OF THE INVENTION IS PROVIDED fuel gas including at least one of syngas and/or hydrogen gas, and/or electricity produced from the syngas or hydrogen stripped syngas obtained in accordance with the first aspect and/or second aspect of the invention.

IN ACCORDANCE WITH YET ANOTHER ASPECT OF THE INVENTION IS PROVIDED a pyrolysis reactor comprising
a body defining a first chamber for containing carbonaceous feedstock and a second chamber separated from the first chamber by a separation member (i.e., a heat exchange wall).

The separation member may be arranged to facilitate heat exchange between heated fluid, such as combustion gas that is fed in the second chamber, and carbonaceous feedstock that is fed in the first chamber.

The first chamber may be located within the second chamber and separated from the second chamber by the heat exchange wall such that the second chamber forms a jacket for the first chamber.

The pyrolysis reactor may comprise a first chamber first inlet for receiving carbonaceous feedstock into the first chamber; a first chamber second inlet for receiving heated pyrolysis gas into the first chamber and/or heated gas arranged to provide the heat required initially to effect pyrolysis; a first chamber first outlet for discharging solid pyrolysed product; and a first chamber second outlet for discharging pyrolysis gas.

The pyrolysis gas arranged to be discharged from the pyrolysis reactor may contain the inert gas.

The pyrolysis reactor may further comprise of a first chamber third inlet for receiving recycled, heated pyrolysis gas into the first chamber.

The reactor may have a second chamber inlet for receiving combustion gas into the second chamber and a second chamber outlet for discharging cooled combustion gas.

### DETAILED DESCRIPTION

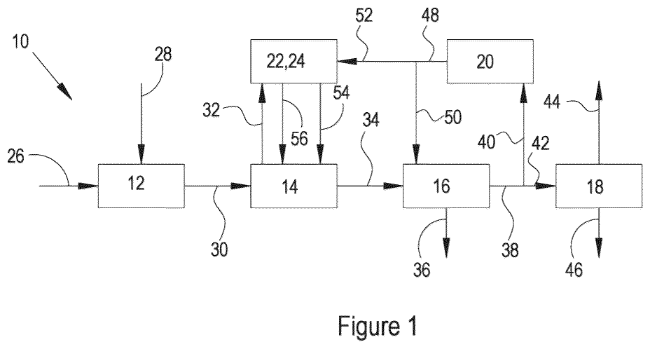

THE INVENTION WILL NOW BE DESCRIBED IN MORE DETAIL with reference to the accompanying diagrammatic drawing shown in FIG. 1.

Referring to FIG. 1, reference numeral 10 generally indicates a process for producing syngas, according to the invention, for performing a method of producing syngas, according to the invention.

The process 10 includes:
a feed preparation stage 12;
a pyrolysis stage 14;
a gasification stage 16;
a syngas treatment stage 18;
a heat generation stage 20;
a heating stage 22; and
gas compression stage 24.

The process 10 further includes:
a solid raw material feed line 26;
a water feed line 28;
a feedstock transfer line 30;
a pyrolysis gas exit line 32;
a pyrolysis product transfer line 34;
a gasification discard product exit line 36;
a gasification syngas product line 38 splitting into first and second branches 40 and 42, respectively;
a treated syngas product exit line 44;
a syngas treatment stage discard product exit line 46;
a heat generation product transfer line 48, splitting into first and second branches 50 and 52, respectively;
a heater product and gas compressor product transfer line 54; and
heater product combustion gas exit line 56.

In the feed preparation stage 12, biomass and/or a fossil fuel-based carbonaceous material is fed along feed line 26 optionally along with water and/or steam which is fed along feed line 28. The biomass and/or fossil fuel-based carbonaceous material is blended with water and/or steam to form carbonaceous feedstock material which is then transferred from the feed preparation stage 12 along the feedstock transfer line 30 into the pyrolysis stage 14.

In the pyrolysis stage 14 comprising a pyrolysis reactor (not shown), heated gas, in particular, heated inert gas that may have been heated by the heat of combustion obtained from combusting a source of fuel such as, natural gas, is supplied along a feed line (not shown) into the pyrolysis reactor (not shown) of the pyrolysis stage 14 to provide the heat required to initiate the pyrolysis process.

The pyrolysis reactor (not shown) comprises an inner/first chamber (not shown) that is located within an outer/second chamber (not shown) that forms a jacket for the inner chamber. The inner chamber (not shown) and outer chamber (not shown) are separated from each other by a separation member (i.e., a heat exchange wall). The heated inert gas is initially fed (i.e., injected) directly into the interior of the inner chamber (not shown) of the pyrolysis reactor (not shown) so as to dispel any oxygen in the inner chamber (not shown) and essentially form an oxygen starved environment within the inner chamber (not shown) while providing the heat required to effect pyrolysis of the carbonaceous feedstock.

The feedstock is transferred, via line 30, into the heated, oxygen starved inner chamber (not shown) of the pyrolysis reactor (not shown) of the pyrolysis stage 14. Once fed into the inner chamber (not shown) of the pyrolysis reactor (not shown), heat exchange occurs directly through contact between the feedstock and the heated inert gas. The heated inert gas is arranged to flow in a direction that is opposite the direction of the feedstock inside the inner chamber (not shown), thereby effecting pyrolysis and producing a solid pyrolysed product and a pyrolysis gas.

Steam, that is exogenous to the process, and/or gases obtained and recovered from the gasification stage 16 (downstream), as will be described below, and/or gases obtained from the pyrolysis stage 14, and/or gases obtained from the syngas treatment stage 18 (downstream) may also be added into the pyrolysis reactor (not shown) in the pyrolysis stage 14, typically in the first chamber (not shown) holding the carbonaceous feedstock, to further the pyrolysis reactions.

The pyrolysis gas is released from the pyrolysis stage 14 along the pyrolysis gas exit line 32 and the pyrolysed product, comprising of solid product such as ash and char, is transferred to the gasification stage 16.

Although not shown, a portion of the pyrolysis gas in exit line 32 may be recycled back into the inner chamber of the pyrolysis reactor (not shown) in the pyrolysis stage 14, without being fed into the heating and gas compression stages 22, 24, respectively, to provide some of the heat required to further pyrolysis.

In the gasification stage 16, the pyrolysed product is converted into gaseous carbon and ash. Typically, the gasification stage 16 comprises a gasification reactor (not shown) which is initially heated externally with heated gas obtained from the combustion of a fuel source, in order to increase the temperature of the gasification reactor to a desired temperature for gasifying the pyrolysed product.

Ionized steam/water is then fed into the gasification stage 16 along a steam/water feed line (not shown) to react with gaseous carbon and thus promote the formation of syngas via steam reformation as is known in the art. The ash is released from the gasification stage 16 along the gasification discard product exit line 36 and the syngas is recovered in a syngas transfer line 38 which splits into a first syngas product line 40 and a second syngas product line 42.

A portion of the formed syngas obtained from the gasification stage 16 which is in the second syngas product line 42 is transferred to a syngas treatment stage 18.

In the syngas treatment stage 18, the syngas is quenched with ionized water that is introduced into the syngas treatment stage 18 via an ionized water feed line (not shown). The quenched syngas is then further treated by subjecting the quenched syngas to purification, in which impurities including, ash, that is entrained in the syngas, is separated from the quenched syngas. Typically, the quenching and purification are effected through the use of filters such as, hydrocyclones. The quenching water containing the impurities including ash, are removed from the syngas and exit the syngas treatment stage 18 via exit line 46. The treated syngas recovered from the syngas treatment stage 18, which is typically dry or substantially dry, exits the syngas treatment stage 18 via product line 44.

Another portion of the formed syngas obtained from the gasification stage 16 which is in the first syngas product line 40 is transferred to a heat generation stage 20.

In the heat generation stage 20, the syngas is combusted via a burner to produce heat of combustion. The heat produced in the heat generation stage 20 is captured in a heated fluid, such as a heat of combustion gas product which is released from the heat generation stage 20 via the heat generation product transfer line 48.

The heat of combustion is transferred by the heat of combustion gas product from the heat generation stage 20 via transfer line 48 which then splits into a first heat generation gas product line 50, which is directed to the gasification reactor (not shown) in the gasification stage 16 to provide at least some of the heat required to perform gasification, either with or without additional heated gas obtained from the combustion of the fuel source as mentioned above, and a second heat generation gas product line 52 which is fed into the heating stage 22.

Although not shown in FIG. 1, it is envisaged that the second heat generation gas product line 52 may be further split into a stream that is fed to the heating stage 22 and another stream that is fed directly into the second chamber of the pyrolysis reactor (not shown) in the pyrolysis stage 14 for providing heat to effect pyrolysis of the feedstock indirectly via the heat exchange wall (not shown).

In the heating stage 22, which is typically in the form of a heat exchanger, pyrolysis gas obtained from the pyrolysis stage 14 and exiting the pyrolysis stage 14 via exit line 32, is introduced into the heating stage 22 where heat exchange is effected between the pyrolysis gas and the heat of combustion in the second heat generation gas product line 52, thus forming heated pyrolysis gas.

The heated pyrolysis gas is then fed into a compression stage 24 to compress the heated pyrolysis gas. After the compression of the heated pyrolysis gas, the heated pyrolysis gas is recycled back into the inner chamber (not shown) of the pyrolysis reactor (not shown) in the pyrolysis stage 14 via transfer line 54, to provide the heat required to perform pyrolysis of fresh carbonaceous feedstock, and/or residual and/or unreacted carbonaceous feedstock remaining in the pyrolysis stage 14, either with or without additional heated inert gas as mentioned above.

The heated pyrolysis gas is recycled back into the pyrolysis stage 14, and typically moves counter current to the direction of the carbonaceous feedstock in the inner chamber (not shown) to take advantage of the Log Mean Temperature Difference of the carbonaceous feedstock and the heated pyrolysis gas.

The cooled combustion gas, that is recovered from the heating stage 22 after effecting heat exchange with the pyrolysis gas in line 32, is transferred via transfer line 56 into the second chamber (not shown) of the pyrolysis reactor (not shown) to provide ambient heating to the inner chamber (not shown) of the pyrolysis reactor (not shown) via the heat exchange wall (not shown), as mentioned above.

In another version of the invention, the portion of the syngas in the first syngas product line 40 may further be split, in which a portion of the syngas in the first syngas product line 40 is directed to a hydrogen separation stage (not shown) and another portion is fed into the heat generation stage 20. The portion of the syngas which is directed and fed into the hydrogen separation stage is stripped of hydrogen. The hydrogen stripped syngas recovered from the hydrogen separation stage (not shown) may be recovered and used downstream in a power generation process. The hydrogen that is recovered from the hydrogen separation stage (not shown) may then be fed into the heat generation stage 20 and combusted, either alone or in combination with syngas in line 40 (or the portion of the syngas which was not fed into the hydrogen separation stage), to form heat of combustion, which heat will then be transferred to the gasification stage 16 and heating stage 22 as described above.

In yet another version of the invention, the treated syngas in the treated syngas product line 44 may further be split in which a portion of the treated syngas in the treated syngas product line 44 is directed to a hydrogen separation stage (not shown), in which hydrogen is stripped from the syngas, and the other portion of the syngas in the treated syngas product line 44 is fed into the heat generation stage 20. The hydrogen stripped syngas recovered from the hydrogen separation stage (not shown) may be recovered and used downstream in a power generation process. The hydrogen that is recovered from the hydrogen separation stage (not shown) may then fed into the heat generation stage 20 and combusted, either alone or in combination with syngas in line 40, to form heat of combustion as described before.

While the invention has been described in detail with respect to specific embodiments and/or examples thereof, it will be appreciated that those skilled in the art, upon attaining an understanding of the foregoing may readily conceive of alterations to, variations of and equivalents to these embodiments.

1. to 22. (canceled)

23. A method of gasifying a carbonaceous feedstock, the method including
pyrolysing a carbonaceous feedstock, by effecting heat exchange between heated gas and the carbonaceous feedstock under non-oxidizing conditions through direct and/or indirect contact between the heated gas and carbonaceous feedstock, and thus producing a pyrolysis gas and a solid pyrolysed product;
gasifying the solid pyrolysed product, thus producing syngas;
producing heat of combustion by combusting at least some of the syngas and/or hydrogen recovered from the syngas;
effecting heat exchange between the heat of combustion and the pyrolysis gas, to produce heated pyrolysis gas; and
using the heated pyrolysis gas to provide at least some of the heat to perform the pyrolysis of the carbonaceous feedstock, until such time as the heat obtained from the heated gas is at least partly or ultimately replaced by the heat obtained from the heated pyrolysis gas.

24. The method according to claim 23, wherein the heated gas is heated inert gas.

25. The method according to claim 24, wherein, in order to obtain the heated inert gas, the method includes the step of combusting a fuel source and using heat of combustion obtained therefrom to heat an inert gas, thus producing the heated inert gas.

26. The method according to claim 23, wherein in the pyrolysing step, the method comprising using the heat of combustion that is contained in a combustion gas obtained from combusting at least some of the syngas and/or hydrogen recovered from the syngas to effect heat exchange with the carbonaceous feed stock.

27. The method according to claim 23, comprising effecting pyrolysis inside of a pyrolysis reactor having a first compartment separated from a second compartment by a heat exchange wall, wherein the second compartment forms a jacket for the first compartment.

28. The method according to claim 27, wherein in the pyrolysing step, the method comprising effecting heat exchange, inside the pyrolysis reactor, between the carbonaceous feedstock and heated gas, heated pyrolysis gas, and combustion gas obtained from the combustion of at least some of the syngas and/or hydrogen.

29. The method according to claim 27, comprising effecting heat exchange directly between the heated pyrolysis gas and the carbonaceous feedstock by directly contacting the heated pyrolysis gas, which is recycled back into the pyrolysis reactor, with the carbonaceous feedstock inside the first compartment of the pyrolysis reactor.

30. The method according to claim 29, comprising moving the heated pyrolysis gas and the carbonaceous feedstock in opposite directions inside of the first compartment of the pyrolysis reactor while the heat exchange is being effected.

31. The method according to claim 27, comprising effecting heat exchange between the heat of combustion obtained from at least some of the combustion gas obtained from combustion of at least some of the syngas and/or hydrogen recovered from the syngas, and the carbonaceous feedstock through the heat exchange wall.

32. The method according to claim 27, wherein the heat of combustion obtained from the combustion of at least some of the syngas and/or hydrogen recovered from the syngas is introduced inside the second compartment of the pyrolysis reactor and arranged to indirectly provide heat into the first compartment via the heat exchange wall and thus provide ambient heating to the first compartment.

33. The method according to claim 23, wherein the carbonaceous feedstock comprises a blend of water, steam, ionized water, and/or ionized steam with biomass and/or a fossil fuel-based carbonaceous material.

34. The method according to claim 23, comprising using some of the heat of combustion obtained from combusting the syngas and/or hydrogen for gasifying the solid pyrolysed product.

35. The method according to claim 23, comprising compressing the heated pyrolysis gas prior to using the heated pyrolysis gas in pyrolysing the carbonaceous feedstock.

36. The method according to claim 23, comprising treating the syngas produced from the gasification of the solid pyrolysed product, wherein the step of treating the syngas includes quenching the syngas in water to reduce the temperature of the syngas.

37. The method according to claim 36, wherein the step of treating the syngas comprising removing impurities including particulate matter entrained in the syngas, from the syngas, thus obtaining treated syngas.

38. The method of claim 23, comprising the step of separating hydrogen from at least some of the syngas and recovering the hydrogen.

39. The method of claim 36, comprising the step of separating hydrogen from the syngas either after the gasifying step or a step of treating the syngas.

40. The method according to claim 36, wherein the syngas that is combusted in the step of generating heat of combustion is a portion of the syngas obtained from the gasifying step and/or obtained from the syngas treatment step.

41. Use of at least a portion of the syngas produced in accordance with the method of claim 23 in a process to generate electricity.

42. Syngas produced in accordance with the method of claim 23.
